(19) United States
(12) Patent Application Publication
(10) Pub. No.: US 2019/0208026 A1
(43) Pub. Date: Jul. 4, 2019

(54) METHOD AND SYSTEM FOR IDENTIFYING USERS ON THE INTERNET

(71) Applicants: Xnet Tech. Co. ,Ltd., Taipei City (TW); uTrust Tech. Co. ,Ltd., Taipei City (TW)

(72) Inventors: Kuan-Jung Chen, Taipei City (TW); Yi-Hsun Lin, Taipei City (TW)

(21) Appl. No.: 15/995,298

(22) Filed: Jun. 1, 2018

Related U.S. Application Data
(60) Provisional application No. 62/611,001, filed on Dec. 28, 2017.

(51) Int. Cl. H04L 29/08; G06F 17/27; G06F 17/30; G06F 21/31

(52) U.S. Cl. CPC H04L 67/22; G06F 21/316; G06F 17/30876; G06F 17/2785

(57) ABSTRACT

This invention provides a method and a system for identifying users on the internet. The method comprises of five steps. First, a tracking code is embedded into a plurality of web pages or platforms. Then, when an anonymous user browses the web pages or platforms, the information browsed and corresponding tracking codes are collected. After the browsed information and the corresponding tracking codes are analyzed, a database is then established for the browsing patterns of the anonymous user. Finally, the anonymous user is identified when he logs in on one of the web pages or platforms.

### CLAIM OF PRIORITY

This application claims the benefit of priority of U.S. provisional application No. 62/611,001 entitled to inventors filed Dec. 28, 2017 and entitled “Method for Identifying Internet User”, the entire disclosures of which are incorporated herein by reference.

### FIELD OF THE INVENTION

The present invention generally relates to a method and system for identifying a user identification technique, and more particularly to a method and system for identifying technique for confirming anonymous users' identities on platforms which provide information for users to browse. However, it would be recognized that the invention has a much broader range of applicability.

### BACKGROUND OF THE INVENTION

The existing website visitor tracking technology is limited to a single electronic device. The cookies from the electronic device are analyzed and the user's behavioral pattern on the particular website is obtained, which is useful for advertisers. However, the amount of data related to users' browsing information stored in cookies is quite limited. Furthermore, even on the same electronic device, there are separate cookies for different browsers, not to mention the situation in which a given user uses different electronic devices. These issues greatly hinder the effectiveness of online advertising.

In addition, each website can only track and analyze its own visitors' browsing pattern. For example, Facebook can track and analyze the users' digital footprints only on Facebook but not on other websites, but other websites or platform cannot obtain those digital footprints on Facebook. There are already many algorithms for analyzing the browsing footprints of a known user, one of which is described in U.S. Pat. No. 9,654,541.

It is impossible to accurately analyze users' browsing patterns across a multitude of websites and electronic devices when there are no sufficient data for the identities of the users. Therefore, the issues with cross-domain and cross-browser tracking lie in the inability to establish users' identities.

### BRIEF SUMMARY OF THE INVENTION

The present invention provides a method for identifying users on the Internet. First, an information tracking system is established on multiple platforms. Then, information browsed by multiple anonymous users on the platforms and corresponding tracking codes are collected. After that, the browsed information and the corresponding tracking codes are analyzed. Next, browsing patterns corresponding to the anonymous users are generated. Finally, the users' identifications are given when they log in one of the platforms.

In the present method, the platforms constructed on an information management system can directly record information of the many anonymous users in the tracking codes.

In the present method, the establishing step is to embed the browsed information from the platforms in tracking codes.

In the present method, the platforms are used to display information, which includes the information displayed at front end websites, interfaces or any application software.

In the present method, the users' information is stored in cookies.

In the present method, the analyzing step comprises semantic analysis for constructing contents of the browsed information.

Furthermore, the present invention also provides a system for identifying users on the Internet. The system includes a content management system for managing and outputting browsed information and tracking codes on multiple platforms, a vehicle for continuously tracking and recording browsed information on the platforms and anonymous user identification information by using cookies, and an analysis engine for constructing the browsed information and the corresponding tracking codes on the platforms, wherein the user is given an identification when one of the anonymous users logs in one of the platforms.

Alternatively, the system can include a content management system for outputting multiple embedded tracking codes into multiple platforms, a vehicle for continuously tracking and recording browsed information on the platforms and anonymous user identification information by using cookies, and an analysis engine for constructing the browsed information and the corresponding tracking codes on the platforms, wherein the user is given an identification when one of the anonymous users logs in one of the platforms. The content management system can be used for recording browsed information and tracking codes on multiple platforms.

In the present system, the platforms are used to display information, which includes the information displayed at front end websites, interfaces or any application software.

In the present system, the users' information is stored in cookies.

In the present system, the analyzing engine comprises semantic analysis for constructing contents of the browsed information.

In the present system, the vehicle comprises a user tracking application system for tracking and transferring information of the many users.

Other advantages of the present invention will become apparent from the following description taken in conjunction with the accompanying drawings wherein are set forth, by way of illustration and example, certain embodiments of the present invention.

### BRIEF DESCRIPTION OF THE DRAWINGS

Further advantages of the present invention may become apparent to those skilled in the art with the benefit of the following detailed description of the preferred embodiments and upon reference to the accompanying drawings in which:

FIG. 1 is a flow chart of identifying users on the internet in accordance with one embodiment of the present invention;

FIG. 2A is a block diagram of identifying users on the internet in accordance with one embodiment of the present invention;

FIG. 2B is a block diagram of identifying users on the internet in accordance with another embodiment of the present invention;

FIG. 2C illustrates a combinational FIG. 2A and FIG. 2B block diagram of identifying users on the internet in accordance with one embodiment of the present invention.

### DETAILED DESCRIPTION OF THE INVENTION

The present invention relates to a method and a system for identifying anonymous users across multiple websites or platforms. This specification of the present invention aims to facilitate and enable any person skilled in the pertinent art to understand, make and use the present invention. Therefore, it should become apparent to those skilled in the art to derive any other variations or modifications of the present invention from this specification. Therefore, the scope of the present invention should not be limited to the embodiment contained herein but should encompass all that aligns with the spirit and features of the present invention.

In the present invention, the tracking codes of User Tracking Application, which will be referred to as “UTA” hereon, are embedded in the front end systems of platforms. Next, the cookies from the users' electronic devices, website information and user identification code are sent to UTA to be compared. UTA then categorizes different users' digital footprints to identify the identities of anonymous users and their behavioral patterns and interests. When an anonymous user logs in any website, the anonymous user's identity is then given.

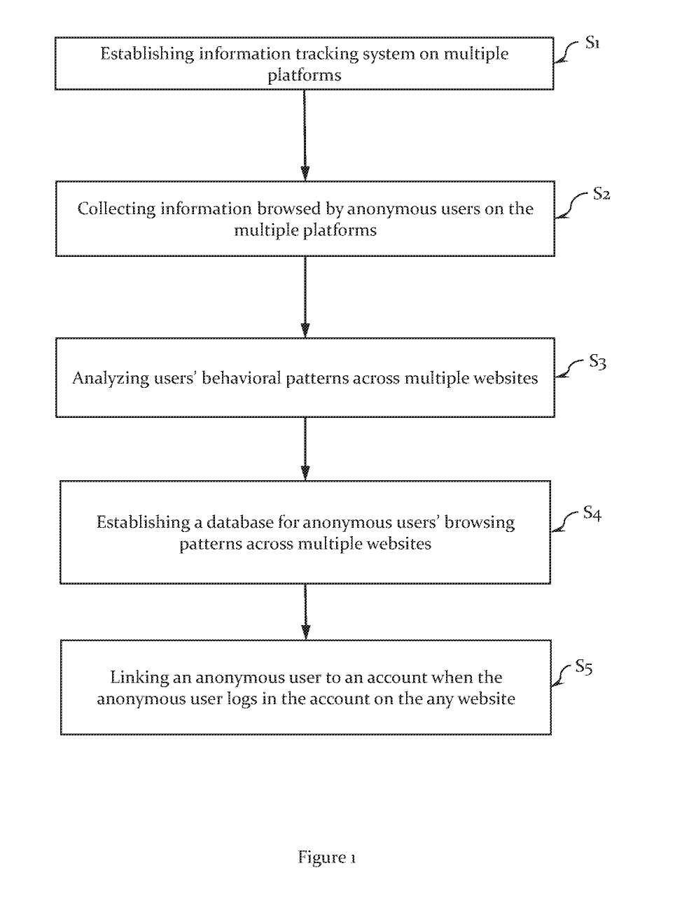

The method of the present invention is illustrated in FIG. 1. As shown in Step 1, labeled as S1 in FIG. 1, the first step of the present invention method is to establish information tracking system on multiple platforms, which, in the present invention, include information appearing in the front end of websites, communication interfaces or any application software. Currently, a lot of communication software, such as WhatsApp, Line and Wechat, can provide information for users to browse without using browsers. For the purpose of illustrating the present invention in a concise and clear manner, a platform will be represented by the front end of a website in a browser hereon.

There are two embodiments in the present invention. The first is to set up a Content Management System (CMS) upon which all the website infrastructures are constructed. The CMS platform directly manages tracking codes which are output to UTA in order to track and transmit user behavioral pattern information, such as website codes, article codes and user identification codes and to store information which is browsed by users and which is related to user behavioral patterns on the Internet. The information browsed and user behavioral patterns may be login account information, items selected, the tags of articles read, search keywords entered, picture types of items selected by users, user IP, users' electronic devices system information, users' browser types and versions and other information needed. The CMS platform in the present invention can be integrated with website systems to directly output user behavioral pattern information and encrypt and embed it in the tracking codes from the websites. The information is then sent to UTA. Anonymous user tracking identification information should be tracked and transferred continuously by using the cookies.

The second embodiment is for websites that do not want to join the CMS platform described above but want to obtain the cross-domain digital footprints of anonymous users. The present invention provides a tracking code, defines the tracking code scope and embeds the tracking code in the front end system to enable the data needed to be transmitted correctly. Anonymous user tracking identification information should be tracked and transferred continuously by using the cookies.

Many collaborating websites may already have their own CMS platform. Therefore, the UTA in the present invention only needs to be linked to the CMS platform to receive the tracking codes from the collaborating websites' platform and then the “footprint or trace” can be sorted according to the present invention in order to identify users on the internet. The tracking codes include website codes, article codes and user identification codes and to store information which is browsed by users and which is related to user behavioral patterns on the Internet.

Step 2 (S2 in FIG. 1) is through embedded tracking codes, encrypted user behavioral information and continuously tracked identification information of anonymous users in cookies to amalgamate anonymous users footprint information across multiple websites into a “vehicle.” The vehicle is mainly used for carrying any information. In the present invention, any computer, workstation, server, or tablet PC with computation and Internet connection ability can be suitably used as vehicle. When a user first browses a website in a browser on an electronic device, anonymous user tracking identification information is recorded first in cookies, and information clicked on or keyed in by the user, including tracking codes, is transferred to the User Tracking Application. When the user visits the website again, cookies on the websites can be used to preliminarily determine the user's identification with analyzed results by analysis engine, in order to decide what kinds of information should be provided. In the present invention, the user identification is usually anonymous as the user entering or visiting the website here.

In the present invention, when a new command is given by the user, the website immediately transmits anonymous user tracking information including previously collected cookies and encrypted user behavioral information to UTA for further processing. Depending on the website system designs, encrypted user behavioral information can be transmitted to UTA at a predetermined interval or at the time when the user's command to close the browser is detected. UTA can include an “encrypted user behavioral information interpreting module”, which can interpret and analyze the text information in encrypted user behavioral information and produce a given user's footprint on a given website according to the text along with user tracking information in cookies.

In Step 3 (S3), users' behavioral patterns across multiple websites are analyzed by “Analysis Engine”. For example, when a user visits Website A, a website collaborating with the present invention's system, in Internet Explorer on his or her laptop and then uses Text Title A, Text Title B and Text Title C to read the related articles, the UTA in the present invention receives the first tracking code from Website A and uses semantic analysis module to analyze Text Title A, Text Title B and Text Title C. Furthermore, UTA uses the first tracking code to produce the first footprint and store it. When the same user visits Website B, another website collaborating with the present invention's system, in Google Chrome on his or her smart phone and then uses Text Title D, Text Title E and a picture with Text Label F to read the related articles and information, the UTA of the present invention receives the second tracking code from Website B and uses “semantic analysis module” to analyze Text Title D, Text Title E and Text Label F. Furthermore, UTA uses the second tracking code to produce the second footprint trace and store it. After UTA receives the second tracking code and generates the second footprint trace, the first and second footprint traces are compared using trace comparison module on UTA. If the trace comparison module determines that the first and second footprint traces are the same or similar and the corresponding user identification provided by the tracking codes are the same, the first and second footprints are categorized into the same group. If the trace comparison module determines that the first and second footprints are different, they are categorized into different groups. With variation in the application of the present invention, the trace comparison module in the UTA of the present invention can proceed to categorize the footprints immediately after the system receives them or wait for a period of time and process multiple footprints. A category can include many footprints and may possibly be categorized under the same user by the present invention's system. Analysis Engine can include a semantic analysis module, which can interpret and analyze the text information in tracking codes. Semantic analysis module can also be in CMS platform, but is preferred in Analysis Engine because this way allows more flexibility for the present invention.

Because the device features of a given user should be the same, even when cookies are disabled or blocked, CMS platform can still use the device features to obtain the user's footprints on various websites and sort them in the same group.

When a user browses websites using different browsers or electronic devices, such as smart phones, tablets, laptops or desktop computers, user tracking application system uses tracking codes embedded in different browsers to obtain multiple footprint traces, via analyzing variant identification characteristic information by the analysis engine to sort the footprint traces into the same group.

In the present invention, most analysis treats each article as a whole and sort according to key formation such as the article tags, article titles or author's own categorization. Another sorting method is meaning or semantic analysis. Semantic analysis involves dividing written text into meaningful segments which are then analyzed using matrix analysis. English is composed of terms, so the analysis of text on English websites is done on terms. On the other hand, written Chinese is composed of Chinese characters or words, so the text on Chinese websites needs to be segmented into meaningful phrases before being analyzed and sorted. There are already many algorithms for segmenting and analyzing article text. This meaning analysis can analyze the article contents instead of only the article tags, article titles or author's own categorization, so it gives better analysis results.

Step 4 (S4) is to establish a database for anonymous users' browsing patterns. After various browsing footprints are produced from the analysis process described above, the related data are grouped together.

In Step 5 (S5), when an anonymous user logs in an account on any websites, the anonymous user is linked to the account. Before a user logs in on any websites, UTA tracks and record the footprints on the same browser by assigning a user identification code (memberID=null) to the anonymous user. As soon as the user logs in on one of the websites collaborating with the present invention, the user is identified and all the previous tracking information is linked to the same user. The tracking, identifying and recording processes will persist.

If a user logs in the same collaborating website on more than one electronic device, such as a smart phone and a desktop computer, UTA can automatically sort all previous anonymous tracking records from those devices under the same user. Furthermore, all future tracking records from those devices will be sorted under the same user until the login account is changed. Identifying users across multiple electronic devices is thus achieved.

For example, when an anonymous user logs in his or her Facebook account, an identity is given to the user in the database described above, so this user's browsing environments on multiple devices can be tracked. When one of the footprints has information related to the user's identification, it will be the identification for the group.

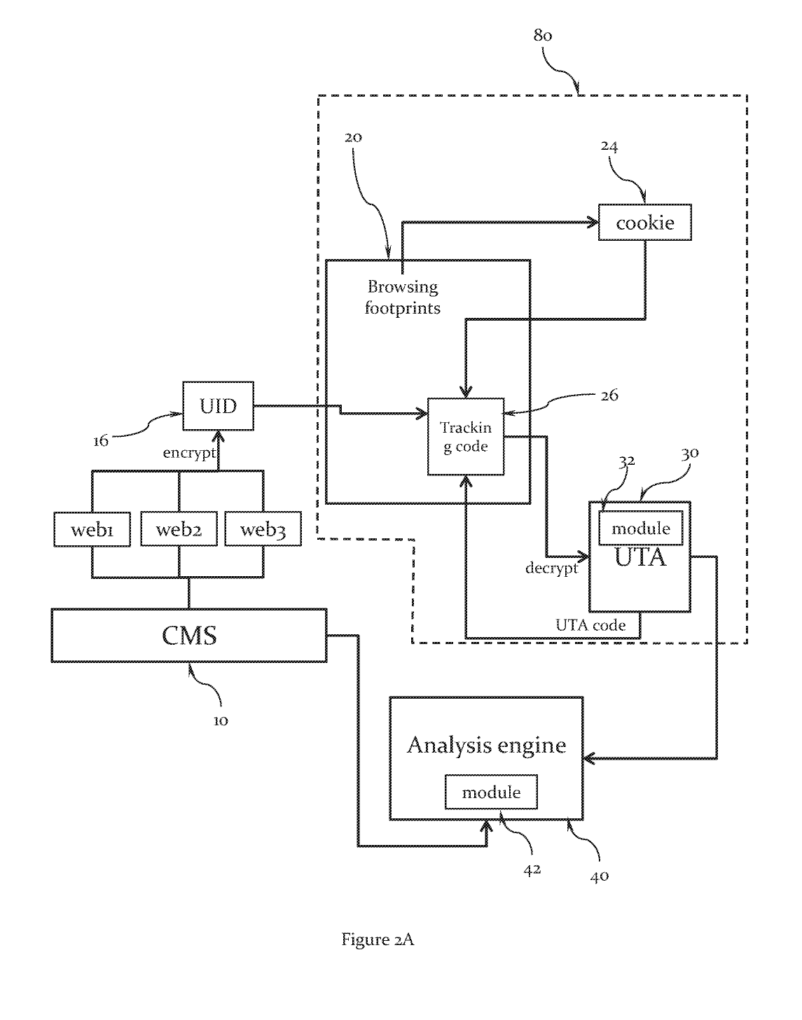

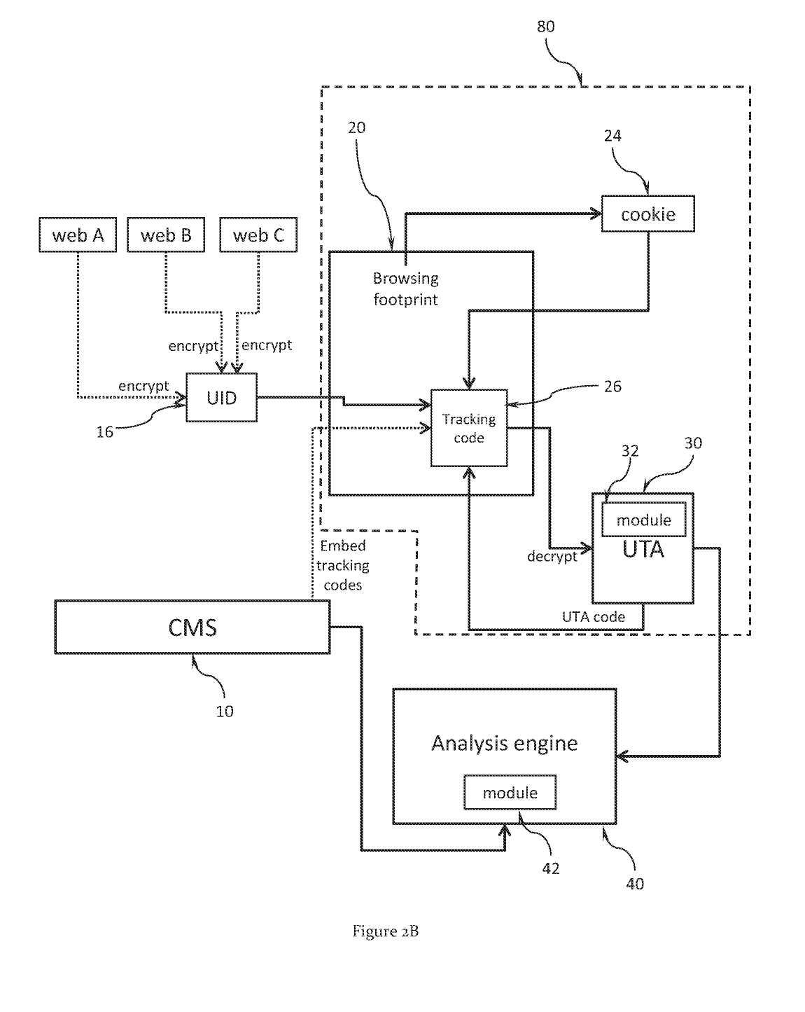

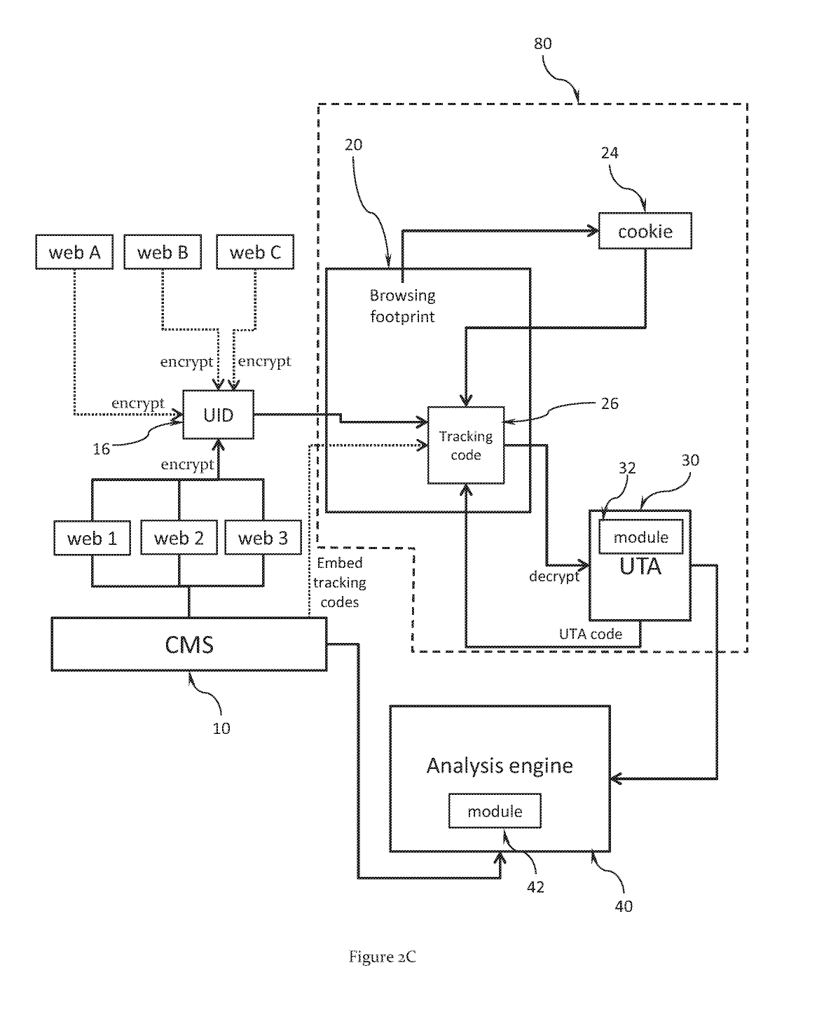

The present invention also provides a system for identifying users on the Internet. Please refer to FIG. 2 along with the flowchart in FIG. 1.

The present invention's system includes a User Tracking Application (UTA) 30 for recording or tracking information browsed by anonymous users and tracking codes, a vehicle for collecting information browsed and tracking codes, and an analysis engine 40 for analyzing information browsed by anonymous users and identifying anonymous users' identities.

Please refer to FIG. 2A. CMS platform 10, as described previously, directly manages and outputs tracking codes on every websites, Web1, Web 2 and Web3, in order to track and transmit data. Web1, Web 2 and Web3 all use CMS platform to set up their own websites and embed the tracking code 26 of User Tracking Application (UTA) 30 in the front end website. The front end and back end platform work closely together to effectively transmit and record encrypted user behavioral information 16, such as article numbering, user login numbering. UTA 30 can include a tracking code interpreting module 32, also named as tracking code tracing module or encrypted user behavioral information interpreting module, which can interpret and analyze the text within the encrypted user behavioral information 16 and produce the footprints of a given user on the website along with user tracking information in cookies. When an anonymous user browses a web page, first encrypt user behavioral information (UID; User Identification) 16 and compile the information into a vehicle 80. The vehicle contains website browsing footprint traces 20, the corresponding cookies 24 and corresponding users' tracking codes 26, all of which are sent to UTA 30 after being decrypted.

All collaborating websites, Web1, Web 2 and Web3, are managed with consistency from front to back end, so a sophisticated and extensive tracking infrastructure can be built upon them. When a user visits websites, Web1, Web 2 and Web3, collaborating with the present invention, UTA 30 will track the user footprints 20 of the user 16 on the websites, produce encrypted user behavioral information 16 and send the encrypted user behavioral information 16 to the semantic analysis module 42 in the present invention's analysis engine 40. The content of the encrypted user behavioral information 16 is analyzed to produce footprints. When these data are sent to analysis engine 40, the analysis engine 40 uses trace comparison module 42 to sort and store the footprints in order to piece together users' behavioral patterns in the future. When an anonymous user logs in on one of the websites, analysis engine analyzes the identity of the anonymous user. Analysis engine 40 can include a semantic analysis module 42, which can interpret and analyze the text within the tracking codes. Semantic analysis module 42 can also be in CMS platform 10, but is preferred in analysis engine 40 because this way allows more flexibility for the present invention.

For collaborating websites with their own CMS platforms, the present invention provides a standard tracking code standard for the front end website. As soon as the websites are modified to output the correct data according to specifications, they can the present invention's analysis infrastructure and obtain the desired data. The present invention's UTA 30 can be incorporated into the websites' system in order to directly process tracking codes.

Please refer to FIG. 2B. For websites, Web A, Web B and Web C, that are not willing to be constructed on the present invention's CMS platform or already have their own CMS platforms, the present invention's system can still cooperate with websites, Web A, Web B and Web C. When users visit the websites, Web A, Web B and Web C, which collaborates with the present invention's system, the websites' CMS platforms, which are not the present invention's CMS system, output data such as the websites' identification codes, article numbering and, if the user has logged in, the account information, etc., which are amalgamated and encrypted into a UID 16 and output and embedded into the websites' tracking codes. All these data are sent to UTA 30 to be recorded and stored. The subsequent analysis processes are as described in the previous example along with FIG. 2A.

FIG. 2C is the result of combining FIG. 2A and FIG. 2B. The present invention's system can recognize the identity of anonymous users regardless of whether the websites' platforms are constructed on the present invention's CMS platform 10 or the websites have their own CMS platforms.

The advantage of the present invention lies in its ability to collect and analyze the browsing patterns of anonymous users across a multitude of websites. In addition, the present invention is able to identify anonymous users by using the information collected when anonymous users log in on collaborating websites.

Although the present invention has been described in accordance with the embodiments shown, one of ordinary skill in the art will readily recognize that there could be variations to the embodiments and those variations would be within the spirit and scope of the present invention. Accordingly, many modifications may be made by one of ordinary skill in the art without departing from the spirit and scope of the appended claims.

What is claimed is:

1. A method for identifying a user on Internet, comprising:
establishing an information tracking system on a plurality of platforms;
collecting information browsed by a plurality of anonymous users on said plurality of platforms and corresponding tracking codes;
analyzing said plurality of browsed information and said corresponding tracking codes;
generating a plurality of browsing patterns corresponding to said anonymous users; and
giving the user an identification when one of said plurality of anonymous users logs in one of the plurality of said platforms.

2. The method for identifying users on Internet according to claim 1, wherein in said establishing step, said plurality of platforms constructed on an information management system can directly record information of said plurality of anonymous users in said tracking codes.

3. The method for identifying users on Internet according to claim 1, wherein said establishing step is to embed said browsed information from said plurality of platforms in tracking codes.

4. The method for identifying users on Internet according to claim 2, wherein said plurality of platforms are used to display information, which includes the information displayed at front end websites, interfaces or any application software.

5. The method for identifying users on Internet according to claim 3, wherein said plurality of platforms are used to display information, which includes the information displayed at front end websites, interfaces or any application software.

6. The method for identifying users on Internet according to claim 4, wherein the information of said anonymous users is stored in cookies.

7. The method for identifying users on Internet according to claim 6, wherein said analyzing step comprises semantic analysis for constructing contents of said plurality of browsed information.

8. The method for identifying users on Internet according to claim 5, wherein said tracking codes are cookies.

9. The method for identifying users on Internet according to claim 8, wherein said analyzing step comprises semantic analysis for constructing contents of said plurality of browsed information.

10. A system for identifying a user on Internet, comprising:
a content management system for managing and outputting browsed information and tracking codes on a plurality of platforms;
a vehicle for tracking and recording browsed information on said plurality of platforms and anonymous user identification information;
an analyzing engine for constructing said browsed information and said corresponding tracking codes on said plurality of platforms, wherein said user is given an identification when one of said plurality of anonymous users logs in one of the plurality of said platforms.

11. The system for identifying a user on Internet according to claim 10, wherein said plurality of platforms are used to display information, which includes the information displayed at front end websites, interfaces or any application software.

12. The system for identifying a user on Internet according to claim 11, wherein the information of said anonymous users is stored in cookies.

13. The system for identifying a user on Internet according to claim 12, wherein said analyzing engine comprises semantic analysis for constructing contents of said plurality of browsed information.

14. The system for identifying a user on Internet according to claim 13, wherein said vehicle comprises a user tracking application system for tracking and transferring information of said plurality of users.

15. A system for identifying a user on Internet, comprising:
a content management system for outputting embedded a plurality of tracking codes into a plurality of platforms;
a vehicle for tracking and recording browsed information on said plurality of platforms and anonymous user identification information;
an analyzing engine for constructing said browsed information and said corresponding tracking codes on said plurality of platforms, wherein said user is given an identification when one of said plurality of anonymous users logs in one of the plurality of said platforms.

16. The system for identifying a user on Internet according to claim 15, wherein said plurality of platforms are used to display information, which includes the information displayed at front end websites, interfaces or any application software.

17. The system for identifying a user on Internet according to claim 16, wherein said tracking codes are cookies.

18. The system for identifying a user on Internet according to claim 17, wherein said analyzing engine comprises semantic analysis for constructing contents of said plurality of browsed information.

19. The system for identifying a user on Internet according to claim 18, wherein said vehicle comprises a user tracking application system for tracking and transferring information of said plurality of users.
